(19) United States
(12) Patent Application Publication
(10) Pub. No.: US 2010/0095077 A1
(43) Pub. Date: Apr. 15, 2010

(54) Method System and Apparatus for Handling Information Related Applications

(76) Inventor: Cary Lockwood, Victoria (AU)

Correspondence Address: JACKSON ESQUIRE;ROGER A. JACKSON, 209 KALAMATH STREET, UNIT 9, DENVER, CO, 80223-1348, US

(21) Appl. No.: 12/441,141

(22) PCT Filed: Sep. 12, 2007
(86) PCT No.: PCT/AU2007/001354

§ 371 Date: Mar. 12, 2009

(30) Foreign Application Priority Data
Sep. 12, 2006 (AU) 2006905025

(51) Int. Cl. G06F 12/14

(52) U.S. Cl. 711/162; 711/E12.103

(57) ABSTRACT

The present invention relates to the field of electronic information handling. In particular, the invention relates to the field of information or data storage and retrieval. In one form the present invention relates to a method, system, and apparatus for data recovery in relation to the back up of office information to both onsite and offsite locations. Preferably, the invention provides for the handling user information, comprising: generating a baseline where the baseline comprises a copy of an initial collection of user information; storing at least a predefined number of subsequent copies of predetermined user information; regenerating the baseline by merging the copy of predetermined user information stored immediately subsequent to a previously generated baseline with the previously generated baseline restoring of data either from the baseline or some other determined time in accordance with the subsequent copies of predetermined user information to a device of the user's choosing.

### RELATED APPLICATIONS

This application claims priority from Australian provisional patent application serial number 2006905025 filed Sep. 12, 2006 by Cary Lockwood as inventor and Cebridge Pty. Ltd. as applicant being entitled as “Data Protection and Retrieval”.

This application claims priority from International patent application serial number PCT/AU2007/001354 filed Sep. 12, 2007 by Cary Lockwood as inventor/applicant.

### FIELD OF INVENTION

The present invention relates to the field of electronic information handling. In particular, the present invention relates to the field of information or data storage and retrieval. In one form the present invention relates to a method, system and apparatus for data recovery and it will be convenient to hereinafter describe the invention in relation to the back-up of office information to one or a combination of an on-site location and one or more remote site locations at any one time, however it should be appreciated that the present invention is not limited to that use.

### RELATED ART

The discussion throughout this specification comes about due to the realization of the inventor and/or the identification of certain related art problems by the inventor. Accordingly, the inventor has identified the following related art.

Today's businesses are to some extent, reliant on data and technology. In today's technology driven business office and/or administrative environment, data backup and disaster recovery solutions may be considered essential for the survival of organizations. Similar information backup considerations may also apply to all information storage devices, such as for example, personal devices like mobile/cell phones, cameras, and media players (e.g. iPods™). Data backup and disaster recovery services may protect crucial business or personal information from being lost. In many known solutions for businesses there is a need to purchase and maintain additional equipment to provide such services. A number of organizations like IBM, Computer Associates, and Data Bank offer backup and recovery solutions and services, which:

Are aimed primarily at large corporate organizations;

Require specialized infrastructure and software, which is proprietary to the supplier;

Are cost prohibitive for small to medium businesses; and

Are resource dependent and restrictive to organizations.

The following table details the risk profiles of each of a number of data backup and disaster recovery options currently available.

| | Operational | Operational | Personnel | Cost |
|---|---|---|---|---|
| Option | Risk | Impact | Required | Impact |
| Mirrored Server | High | High | High | Medium |
| In-House (Tape | High | High | High | Medium |
| Drive) | | | | |
| IBM, CA and Data | Medium | Medium | Medium | High |
| Bank | | | | |

It has been considered that approximately 93% of businesses may go bankrupt after data loss, yet, only about 5% of companies insure against data loss'. It has been estimated that two out of five enterprises that experience a disaster of some kind of data loss may go out of business in five years and that approximately 80% of businesses that suffer a serious disruption and have not planned for it, may cease trading within 18 months of the event. Furthermore, it is considered that companies that are not able to resume operations within 10 days of the disruption may not be likely to resume trade at all.

Companies may be required to identify, document, test and evaluate the effectiveness of internal controls over financial reporting. As companies rely heavily on computer applications they also have to ensure that there are adequate controls in their Information Technology (IT) operations.

Many companies are using the Control Objectives for Information and related Technology (COBIT) framework for their IT operations. COBIT has been developed as a generally applicable and accepted standard for good IT security and control practices that provides a reference framework for management, users, information systems audit, control and security practitioners (also see 1S017799—a detailed international security standard).

A recent IDC (International Data Corporation) study analyzed and summarized the market trends in the tape automation industry and its vendors, and it provided the actual quarterly shipment data for 2004 and 2005. This study covers tape automation forecasts' of revenue and shipments for 2006-2010 and summarizes various metrics (e.g., library size, technology, and vendor shares) specific to each market segment. The study offers near-term and long-term expectations for demand, vendor execution, and industry dynamics as well as suggested strategies for industry participants. The following statement was made from that study.

“The worldwide tape automation market will experience modest shipment growth through the forecast period. However, market revenue will decline as high-volume tape automation products increasingly become commodities. We expect long-term tape automation market value will be adversely impacted by hardware-based disk backup solutions, tighter integration of virtual tape library application software, and the trend away from direct-attached tape solutions,” said Robert Amatruda, research manager, Tape and Removable Storage, at IDC.

This IDC study updates the previously published Asia/Pacific (Excluding Japan) Branded Tape Automation 2005-2009 Forecast and Analysis (IDC #AP264200M, July 2005). It relates to the tape automation market and provides the following market data:

A summary of the market in Asia/Pacific (excluding Japan), or APEJ, in 2005;

Revenue and unit shipments broken down by country, technology/format, and library size;

Forecasts of the market from 2005 to 2010 for the region, as well as a separate section for each of the 12 countries covered in the region, by library size.

A further statement from the July 2005 analysis is as follows:

“The APEJ market for branded tape automation systems experienced robust growth in 2005 due in part to increased end-user awareness of data protection and business continuity. However, continual pressures from the increasing capacity of HDDs, new generation disk storage systems, the acceptance of virtual tape libraries (VTLs), the rapid adoption of storage consolidation projects and the implementation of D2D2T (disk to disk to tape) architectures are expected to attenuate the growth of the market over the next five years,” observes Cheryl Ganesan-Lim, associate market analyst, Storage Research, IDC Asia/Pacific.

In co-pending Australian patent application No. 2002318977, the present applicant describes a system for backing up data generated by a business, which comprises a method of preserving electronic data which is created in a generating location, recording the data in an offsite location in a form which is capable of re-creating the data in the event of loss or corruption of the original and storing the recorded data in a safe location.

Businesses and operations which use computers generate data which they need to keep and use. Manufacturers may supply computers with tapes which record data day by day. Alternatively, much work may be batched on storage disks and staff working in the business may select and retrieve data according to the needs of the business. Operators may experience failures in these backup procedures. If a personal or business data processing device (PC or fileserver) is stolen, the in situ backing device may also be stolen at the same time. Disks may be appropriated by departing employees and boxes of disks may be easily destroyed by fire or disturbed by magnetic fields that may be generated by other equipment.

Using a tape system for backups and restoration of data may be labor intensive and potentially non compliant with new technology and systems either in terms of capacity or speed. Tape regimes may usually be implemented with a grandfather, father, son approach, meaning that for instance, if a file was created on a Monday and deleted on a Tuesday in the middle of the month, the data may be lost forever because the daily tapes may be rotated and overwritten again and again, the weekly capture may not have had a chance to back the data up and the monthly/yearly backup would have certainly missed it. Even if it were somehow captured through one of these tape regimes, trying to locate the specific tape from which to restore may be like trying to find the proverbial needle in a haystack. To illustrate, a particular scenario may be that, a file being created approximately 12 months ago was accidentally deleted 2-3 days later and at the present time the file was needed within 24 hours. Such queries may be commonplace in a business.

By using a tape system for backups and placing these tapes in an offsite facility, a disadvantage to the user is that there may be no immediate onsite restoration facility.

When a backup procedure is applied to the records of a sample business, a backup unit may be installed in the user's premises. A typical backup unit is described in applicant's co-pending application No 2002318977. The unit described therein may receive input via a LAN (local area network); it may then store, compress and encrypt the data, then prepare another copy of this same data so as to send its output using a telecommunication connection (for example, normal telephone fixed land line, Internet connection or preferably using a virtual private network) to an offsite recording site which also stores the backed up data. As the volume of stored data increases and the requirements of additional copies also increase, the data may also be sent electronically to another offsite storage facility or freighted to a longer term secure storage facility. The requirements for these sites are as described in the above referenced co-pending application.

With respect to current mainstream source data replication solutions, once a file is deleted at the source, it is also usually deleted on the system that houses the replication thereby totally removing the source data from future restoration possibilities.

Taking a “complete image” approach to data backup may restrict the restoration capability. For instance, taking an image approach on a piece of hardware that may be 3+ years old with that hardware failing may require that the hardware needs replacement. Having a piece of hardware that is exactly the same for this type of restoration may be of vital importance and, trying to find that piece of hardware in an ever evolving marketplace could prove very challenging and perhaps fruitless. Furthermore, having a tape regime for backup in place may present the same challenges and may require access to the same type of tape hardware (and associated software) for data restoration.

Businesses may vary in their particular requirements to capture and restore data. For instance, users may wish to know how much compression, for example, there is in a backup copy of data. Also, users may wish to define the strength of a data encryption key. Users may also desire a data backup overlap, for instance users may require that while the backup is initiated every 24 hours, that the backup being performed looks at all data that has changed in the previous 48 hours. Users may require that the second and subsequent backup only have incremental data, which is data that has changed since the last backup was performed. Users may require that only differential data be backed up after the initial data backup. Users may require that a complete snapshot of all data be instigated each and every time.

Data capture may be influenced by the security policy of the business. For instance, if the restoration of the data to the user is web based, it may be impossible to maintain security in a conventional backup system. For example, at present with traditional or conventional systems, there may be no or little differentiation between the types of security levels a user can restore meaning an administrator may be capable of restoring all files and may not be able to delegate that authority, whether that relates to a file restoration or a backup configuration.

An internal attack, a rampant Trojan or a virus may represent a serious risk to all organizations. Restoring an organizations data up to and including a certain point in time and not simply the time of the previous backup may be vital to recover from these types of threats.

Any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure and claims herein.

### SUMMARY OF INVENTION

An object of the present invention is to alleviate at least one disadvantage associated with the related art.

In a first aspect of embodiments described herein there is provided a method of handling user information, the method comprising the steps of:

generating a baseline where the baseline comprises a copy of an initial collection of user information;

storing at least a predefined number of subsequent copies of predetermined user information;

regenerating the baseline by merging the copy of predetermined user information stored immediately subsequent to a previously generated baseline with the previously generated baseline.

Preferably, the step of regenerating the baseline is performed when the number of subsequent copies stored equates to the predefined number +1 and thereafter repeating the step of regenerating the baseline for each copy of predetermined user information stored subsequent to when the number of subsequent copies stored equates to the predefined number +1.

The predetermined user information comprises one or a combination of:

incremental user information;

differential user information;

incremental user information plus a user requested amount of differential user information;

a complete collection of user information;

user file data;

access control lists;

VERS information and/or associated constructed meta data tags;

user information that has changed prior to storing a previous copy of predetermined user information.

The predefined number may be an integer n, such that n is greater than or equal to 0.

In the event a portion of user information is deleted in a subsequent copy, a previous copy of that portion may be retained in at least one of the previous copies or the baseline.

Compressing copies of the user information may be performed prior to the steps of: generating a baseline; storing at least a predefined number of subsequent copies of predetermined user information, and; regenerating the baseline.

Further, the step of performing a first encryption of copies of the user information may be done prior to the steps of: generating a baseline; storing at least a predefined number of subsequent copies of predetermined user information, and; regenerating the baseline.

The actual transport of the encrypted copies of the user information to at least one offsite facility may also be encrypted with another encryption key to add another layer of security. Therefore, a second encryption may be performed where the second encryption comprises an encryption of the transport of previously encrypted copies. Further, the second encryption may be a further encryption of the previously encrypted copies for further heightened security.

The, steps of compressing, encrypting, storing and securing the transport of data may be performed at one or a combination of the onsite backup unit and the at least one offsite facility.

The onsite backup units and offsite facilities may be allocated their own respective predefined number of subsequent copies of data.

The encryption may comprise encryption keys using at least one version of one or more of the following algorithms:
DSA;
RSA;
AES;
DES.
   Wherein the encryption keys may comprise a key length in the range 128 bits to equal to or greater than 2048 bits.

Further to this, restoring user information may be performed where the step of restoring comprises:

providing a user access to anyone or a combination of:

a) a current regenerated baseline;

b) at least one previously generated baseline;

c) at least one of the subsequent copies of stored predetermined user information.

In another preferred embodiment there is provided apparatus for handling user information comprising:

generating means for generating a baseline where the baseline comprises a copy of an initial collection of user information;

storing means for storing at least a predefined number of subsequent copies of predetermined user information;

regenerating means for regenerating the baseline by merging the copy of predetermined user information stored immediately subsequent to a previously generated baseline with the previously generated baseline.

The regenerating means may be adapted to regenerate, the baseline when the number of subsequent copies stored equates to the predefined number +1.

The regenerating means may be further adapted to regenerate the baseline for each copy of predetermined user information stored subsequent to when the number of 20 subsequent copies stored equates to the predefined number +1.

The apparatus may further comprise data compression means for compressing copies of the user information prior to:

generating a baseline;

storing at least a predefined number of subsequent copies of predetermined user information, and;

regenerating the baseline.

The apparatus may further comprise data encryption means for performing an encryption of copies of the user information prior to:

generating a baseline;

storing at least a predefined number of subsequent copies of predetermined user information, and;

regenerating the baseline.

Preferably, the baseline and subsequent copies of predetermined user information are stored in at least one onsite backup unit.

The apparatus may further comprise:

second encryption means for performing a second or subsequent encryption of copies of the user information;

transporting means for transporting the encrypted copies of the user information to at least one offsite facility in either a clear state or using an encrypted transport tunnel.

The data compression means, any and all encryption means, storing and transporting means may be located at one or a combination of the onsite backup unit and the at least one offsite facility.

Each of the onsite backup units and offsite facilities may be allocated their own respective predefined number of subsequent copies.

The apparatus may further comprise restoration means for restoring user information wherein the restoration means is adapted to:

providing a user access to anyone or a combination of:

a) a current regenerated baseline;

b) at least one previously generated baseline;

c) at least one of the subsequent copies of stored predetermined user information.

In embodiments of the apparatus a user access may be provided through a web interface with provision for a user defined username and password.

The apparatus may further comprise write means for writing the restored user information into one or a combination of:

a location corresponding to its original place in the initial collection of user information;

a location corresponding to its original place in the initial collection of user information with a different name to prevent overwriting the original user information;

an alternate location.

The alternate location may comprise of one or a combination of: an alternative/new directory/folder; an alternative/new device located onsite with the user; an alternative/new device located offsite from the user. The storing means preferably comprises RAID or SAN storage facilities.

In another embodiment the present invention provides for a data format comprising stored predetermined user information where the predetermined user information comprises one or a combination of:

incremental user information;

differential user information;

differential user information plus the required overlap of required user information;

a complete collection of user information;

user file data;

access control lists;

VERS information and/or associated constructed meta data tags;

a complete collection of user information;

user information that has changed prior to storing a previous copy of predetermined user information.

The data format may be such that the stored predetermined user information comprises one or a combination of encrypted and compressed information.

The user information described herein may be derived from one or a combination of:

application servers;

mail servers;

database servers;

web servers;

file servers;

desktop PC's;

other data storage devices such as mobile CD's, DVD's camera's, iPod™s, USB's etc.

In a preferred embodiment there is provided apparatus adapted to handle user information, said apparatus comprising:

processor means adapted to operate in accordance with a predetermined instruction set,

said apparatus, in conjunction with said instruction set, being adapted to perform at least one of the method steps as disclosed herein.

In yet another preferred embodiment there is provided a computer program product comprising:

a computer usable medium having computer readable program code and computer readable system code embodied on said medium for handling user information within a data processing system, said computer program product comprising:

computer readable code within said computer usable medium for performing at least one of the method steps as disclosed herein.

In one other preferred embodiment of the present invention there is provided a method of and means for preserving electronic data which may be generated at a source location. The data may be copied/transported from the source location to at least one firs onsite backup device that stores and manipulates the data, the method comprising the steps of:

backing up the copied data to the first onsite device;

optionally selecting an amount of compression then compressing and then optionally encrypting the data;

preparing the data (preferably in its compressed and encrypted state) for offsite transport and offsite storage via the first onsite storage device to establish an initial complete collection of the electronic data;

backing up a number of subsequent data increments where the number of increments is n; where n is an integer such that n is greater than or equal to 0;

merging the first of the subsequent data increments with the collection when the number of increments reaches n+1 and;

thereafter enlarging the collection by stepwise mergers.

In the above noted embodiment, the number n may be configurable. If n is 1 or 2, then a number of different backups may not be available from the device for very long because the arrival of the next or subsequent batch of data may trigger the merger and the enlargement of the collection.

In an exemplary application of preferred embodiments of the present invention backups of data may be performed. The backups themselves may be configurable in as much as, while a generally accepted notion of backup, for example, an incremental backup (i.e. the copying and storage of data which has changed since the last backup) may apply; the solution of preferred embodiments has the additional notion of allowing backups to have overlap. For instance, a backup may be configured to occur every 24 hours and the configuration of the backup may also comprise looking for data that has changed in the previous 48 hours. In this respect, the notion of overlap may be achieved and not simply a backup of incremental data in the conventional sense.

A backup unit in a preferred form may be onsite and its purpose is to be a repositioning for the periodic, usually daily, data generated at the site. Another purpose of the backup unit is to compress and encrypt the collection of the backups and to send them by a telecommunication connection (normal telephone line, Internet connection or ideally using a virtual private network) to an offsite recording facility. The transport itself may also be encrypted with another encryption key. The backup unit may be as described in 10 applicant's co-pending Australian application No 2002318977.

The offsite storage of the backup data which receives the data from the onsite backup unit may also have I to n of backups. If n is 0 or I, then a number of different backups may not be available from this device for very long because the arrival of the next or subsequent batch of data may trigger the merger and the enlargement of the collection. Alternatively the offsite data backup may have n where n is very large thereby having as close as practicable to infinity incremental backups without any merging of data occurring.

Backup may be continuous or periodic. For example every 24 hours file servers and unit servers may receive automatic backup every 24 hours, database servers every 6 hours and workstations every 7 days. Preferably the storage medium comprises disks.

Preferably, in addition to capturing target or normal file data, underlying access control lists may be captured. Such access control lists may comprise associated file attributes. Furthermore, relevant compliant components may be captured and also created such as, for example, Victorian Electronic Records Strategy (VERS) compliant components and/or other associated meta data tags.

By using disks and utilizing easy to expand storage arrays such as a redundant array of independent disks (RAID) and storage area networks (SANS) means that the amount of storage being backed up is not limited to the initial device chosen by the user for data backup. For example an organization using tape devices may be limited to the initial amount of data that the tape device can store, whereas with an exemplary use of the embodiments described herein there may be no limitation to the amount of data that can be stored and therefore being able to continually grow over -time. By use of RAID and SAN storage facilities, backup and restoration may be achieved in less time than traditional tape regimes. Further, by having a backup unit as an independent device, it may be easily scaled and be capable of moving with a user or organization. This can also apply to offsite facilities in accordance with preferred embodiments.

On predefined time periods, the backup unit of preferred embodiments may automatically back up, selectively compress and selectively encrypt the changes in business data with its own unique encryption key using well defined encryption algorithms (e.g. DSA, RSA, AES, DES) with varying key lengths (e.g. 128 bit to 2048 bit and beyond). The exact algorithm/key length chosen may be dependent upon the user requirements.

Once a data backup is complete, the backup unit of preferred embodiments prepares the data for transport. This transport may use another unique user encryption key using a telecommunication connection (normal telephone line, internet connection or ideally a virtual private network) to connect another backup or storage unit in an operations centre. This connection may be established in order to transport the changes of the business data, where it is preferably backed up for a second time.

In preferred embodiments, at no stage is the transported data or its transmission to the second and subsequent sites exposed to human hands. In this respect, tapes, CDs, DVD's, for example, require a human hand to touch these in moving the data to an offsite location, preferred embodiments of this invention remove that necessity. Furthermore, all data transmission is totally secure from interception by undesirable parties because the data may be encrypted and the transmission of the data is encrypted with another key. And if the transmission is interrupted, it may simply reconnect and continues from where it left off by keeping a log of what piece of data it is up to and waiting for the connection to be established to continue the transport. If for whatever reason the transport corrupts the data, the transmission of data to the offsite location is resent. Each piece of data is “check summed” before during and after transport to ensure its integrity which may be provided by a number of algorithms used to check the integrity of data that would be recognized by the person skilled in the art. The user also has the option to have this offsite data sent to a second or subsequent offsite storage facility, for complete data protection.

Preferably, a backup system can either backup as a user or user organization works or alternately schedule the backup at certain time of the day and at all times the data may be compressed and encrypted with the organizations own unique encryption key. Although the same encryption key can be used for all users while each have a different transport encryption key and vice versa, however the most secure approach is to have a unique encryption key for each users data and each users transport.

The user or solution provider can quickly restore data using an easy to use web browser interface by entering an authorized username and password combination, the user may be presented with a series of menu's to choose from, before being able to select the file(s) and/or directory(s) for restoration. The user may be required to enter a different password for the data decryption. This web browser interface may also deliver reporting, data search, backup status, backup configuration and other backup unit status features. Both the onsite and offsite storage facilities may be able to have a rolling version of the data for any period of time the organization requires. By way of example n may equal 30 on the onsite facility and n may equal 0 to a very large number close to infinity on the offsite facility.

In a preferred arrangement, should an originating device fail, and an immediate replacement originating device may not be immediately available, the data to be restored does not necessarily need to be restored back to the device (or server/workstation) it originated from. For example a file server fails, a replacement server won't be physically available for 24 hours, but the user needs to access their file(s) while the replacement server is being sourced, the data can be restored to a device of the Users choosing 20 enabling the business to continue operating. Other business products on the market place today require the originating device to be up and operational (even CD's/DVD's etc. require some hardware and associated drivers to be loaded to work or to have a tape drive and associated software already preloaded—all the preferred embodiment needs is a very common network interface card which all computers now have as standard for restoration. With preferred embodiments there is no software or special hardware loaded on the target devices; it is ‘possible to place the recovered/backed up data to a device of the users choosing instantly or immediately.

In a preferred system, where security is paramount, for example as in most business environments, no two encryption keys are the same, they may be password protected and these passwords are not stored in either the operations center or additional offsite storage areas, meaning a user's data cannot be “accidentally” unlocked in either offsite location.

The encryption keys being used do not necessarily need to reside on the backup unit, instead these keys could be, stored and accessed on some other medium that interfaces with the onsite backup unit for example on a USB stick resident at another facility that the backup unit has timely access to. These encryption keys and their access may be required for both encryption and decryption.

Preferably, the onsite backup unit has firewall and username password protection protocols in place securing it from attack within or connected to the organization it is servicing.

An onsite backup unit in accordance with preferred embodiments can also be configured to have physical security in the form of a propriety interface for screen and keyboard controls; and a key lock power switch.

Preferred embodiments may deliver the utmost in security for offsite’ data transport. This is because firstly the data is compressed and encrypted, then the data before transport may be “split” i.e. segmented at the backup unit and reconstituted, (reassembled) at the offsite facility and thirdly the transport session is encrypted with another encryption key. In the event the transport session is “hacked”, it may still be necessary to “grab all the bits of data being transported” and then put all these bits together correctly before then going through the process of decrypting and decompressing the data. Even then with the way the data is backed up and the data stored, a hacker will then need to ensure that they have taken all the necessary data components including and not limited to, for example, access control lists (ACL's), associated file attributes and capturing (or creating) Victorian Electronic Records Strategy (VERS) and/or meta data tag compliant components.

In the context of this specification the terms “differential data”, “incremental data” and “overlap” have the following meanings.

Differential data equates to data that has changed since the last FULL backup;

Incremental data equates to data that has changed since the previous backup whether or not that was a FULL backup.

Overlap relates to the backing up of data in an incremental sense plus backing up data that may have changed prior to or earlier than the previous backup. In other words, in accordance with preferred embodiments of the present invention, it is possible to take an incremental data backup with the application of the overlap aspect, that is, an incremental backup will only take changes since the last backup, yet there is the added option of being an incremental plus, which may well mean a differential if the overlap defined by a user is big enough.

Other aspects and preferred forms are disclosed in the specification and/or defined in the appended claims, forming a part of the description of the invention.

Advantages provided by the present invention comprise the following:

Organization may be provided with a powerful, easy to use, efficient, cost effective, secure data backup and disaster recovery solution.

A secured and completely managed data backup and disaster recovery service is provided that:

Ensures a user backup will be done automatically versus current manual driven processes;

Provides a proven alternative to other backup and restoration methods that may be considered “future proof”;

Does not load any software onto a user's network;

At all times the user's data may be encrypted with individual (128 to 2048-bit and beyond) encryption key and totally secures data from access by unauthorized (and undesirable) parties;

Stores the user's data in both on-site and off-site locations;

Will recover individual file(s) and directories within minutes versus hours with present methods;

Will recover an entire business's data within hours versus potentially days with present methods;

Works on all operating systems; and

Will quickly and easily scale so as to continue to support a business as it grows.

Ensures critical business information is available when any form of disaster strikes protecting an organization from potential revenue loss, intellectual capital loss, business collapse, or non-compliance to government regulation.

Have all data automatically encrypted and stored in geographically distinct locations for maximum security.

Ensures organizations are fully compliant with all government regulatory obligations (including and not limited to Sarbanes Oxley, Privacy Act, Security Commissions like the Australian Securities and Investment Commission and Government Taxation records requirements) and therefore the COBIT framework.

Reduce business risk, costs, computing infrastructure and staff effort.

Lets businesses have complete protection of company data assets and information.

Allow organizations to perform their backup without interrupting crucial business systems, operations or networks.

Reduce loss of data, even if the data is deleted, subjected to an attack or infected with a virus.

Always secures and encrypts (if required) the backed up data; and

Provide accountability and business continuity to business owners, shareholders and operators.

No software is loaded onto target devices for which the solution is backing up data from.

The solution works independently from the devices whose data it is backing up thereby being able to backup data from a myriad of operating systems (including and not limited to Windows, Unix, Novell etc) and not be operating system dependant.

The solution removes the “human hand” from the data backup process and automates the backup processes.

The backed up data may be secured (physically and logically) in storage and offsite transmission, furthermore the data may be compressed and may be encrypted.

The data may be stored in both onsite and offsite locations.

Data can be recovered from both onsite and offsite locations.

The solution is “easy to use” and is driven by business need, business security and business data protection and retention policies.

The solution uses “off the shelf” hardware components and is flexible enough to incorporate future hardware advancements as they become available, moreover the solution is cost effective.

The solution may use the IP standard for its underlying communications.

The solution ensures that a user's data cannot be accidentally mixed with other user's data because of the use of difference encryption keys and associated data separation protocols such as unique user number or user name.

The solution is flexible and configurable as to how much data is stored in both on and offsite facilities.

The solution protects an organization from either accidental or malicious data loss, irrespective of the time it has taken to discover that data loss.

Eliminates a whole series of alternative and external devices, processes and services to enable automated on and offsite data backup and disaster recovery for an organization.

Further scope of the applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein, and in which:

FIG. 1 illustrates the generation and regeneration of a baseline and the storage of copies of user information in accordance with a preferred embodiment;

FIG. 2 is a schematic illustration of a system for the backing up of user information in accordance with a preferred embodiment and storing this backed up data in 20 a number of distinct offsite locations in accordance with a preferred embodiment;

FIG. 3 is a schematic illustration of a preferred build engine for building backup and storage units in accordance with the embodiments;

FIG. 4 is a schematic illustration of the ongoing building, management, maintenance, licensing and updating of backup units and offsite facilities in accordance with a preferred embodiment;

FIG. 5 illustrates a related art arrangement that has a number of devices and functions ‘deleted’ for the purposes of illustrating what savings in resources can be achieved with preferred embodiments of the present invention; and

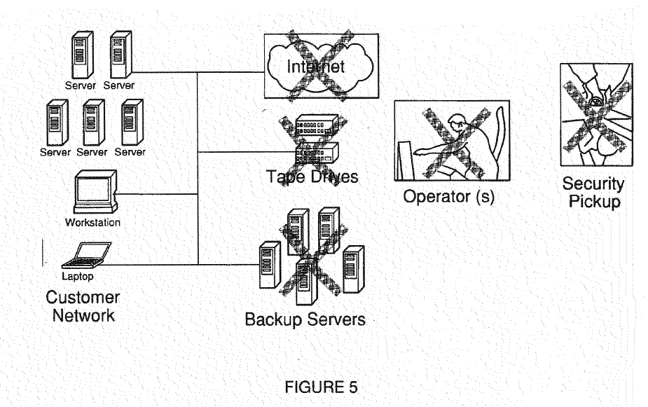

FIG. 6 is a further schematic diagram illustrating a backup system and approach in accordance with a preferred embodiment.

### DETAILED DESCRIPTION

In accordance with a preferred embodiment of the present invention, a user may have an office containing, inter alia, a group of PCs that may form workstations, at least one file server, at least one mail server, and at least one database server. The office may be considered as a generating location of information that may require backup and/or restoration. A backup unit of a preferred embodiment may firstly store the backed up data in an on-site location and also send a second backup data comprising the generated information to an offsite storage facility and subsequently the data may also be electronically transported or freighted to another permanent storage facility.

A hard drive in the backup unit may take a complete snapshot of the user's information or data to establish a copy of an initial collection of user information or an initial collection of content. The data of the first information set is then optionally compressed, encrypted with the backup unit's own encryption key using, for example, DSA, RSA, AES, DES and the like with varying key lengths, e.g. 128-2048 bit and prepares the first information set for transmission. The path between the office PCs and the backup unit may be guarded by a firewall.

By way of example, the backup unit may be configured to backup data at 24 hour intervals from the file servers, backup data from the mail servers at 6 hour intervals on the database server and backup data at 7 day intervals from the workstations. Failure to initiate the backup or perform connection at the time prescribed may set off a series of alarms at onsite and/or offsite locations and associated devices. The user or an administrator may receive a splash screen alert, email, SMS and/or other audible or visible alarms.

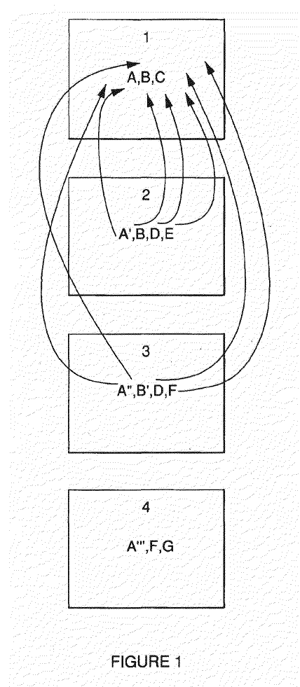

With reference to Figure I, the manner in which the continually generated information and/or data is merged into an initial collection or first information set 25 proceeds as follows. For example the collection initially comprises of files A, B, and C on the first backup. This first information set as established may be referred to as a baseline. In this instance, files by the names of A, B, and C are backed up, see box 1. By way of a simplified example as shown in FIG. 1, an overall backup regime may be implemented having a baseline plus 2 backups, where the number of increments of backing up 30 correspondingly equates to 2. The backup may be instigated every 24 hours and have a configuration in which each backup also looks for information or data items that have changes in the previous 36 hour period, i.e. beyond the backup instigation period and beyond the traditional incremental backup regime. Should the backup have not occurred for whatever reason for over 48 hours, that backup may simply take into account all changed items since the last successful backup.

On a second backup (baseline+1), files by the name of A′, B, D, and E are backed up. A′ is the file A that has changed since the last backup. File B was initially created 5 within the predefined 36 hour window and so it is included in the second backup. Files D and E are new files that have been created in the 24 hour backup period. See box 2.

On a third backup (baseline+2), files by the names 0′£ A″, B′, D, and F are backed up. A″ is the file A′ and B′ is the file B that have both changed since the last backup. File D was initially created within the already defined 36 hour window. File F is a new file that has been created. See box 3.

On a fourth backup (baseline+3), files by the names of A′″, F, and G are backed up. A′″ is the file A″ that has been changed since the last backup. File F was initially created within the already predefined 36 hour window. File G is a new file that has been created. Because in this example n=2, the backup has now reached baseline n+1, therefore the backup closest to the baseline i.e. the one immediately subsequent to the generation of the baseline (Box 2) is merged into the baseline. This means that the baseline contains A′, B, C, D, and E.

If another backup is to occur, another merge of the baseline would occur by way of a merging of the baseline. In this instance (Box 3) A″ would replace A′, B′ would replace Band D and F would also be merged meaning that the new baseline would contain A″, B′, C, D, E, and F. In this instance, you don't actually delete the document or file you simply replace it with a newer version. Now by the way of further example, say you created a file called document v I.doc and then the next day you opened and updated document v1.doc but actually saved it as document v2.doc, document v2.doc doesn't replace document v1.doc and you have both document v1.doc and document v2.doc. To illustrate this point further, say you deleted document vI.doc as you were creating document v2.doc, then the embodiment described here will not delete document vI.doc.

### Restoration

In accordance with preferred embodiments, the notion of restoring files and/or directories or other user information or data forms from a moment in time, for example, as follows.

Restoring all user information or data at a time index of baseline +1 would yield files A′, B, C, D, and E.

Restoring all user information at time index baseline +2 would yield files A″, B′, C, D, E, and F.

Restoring all user information at time index baseline +3 or in this example, at a current time, would yield file A′″, B′, C, D, E, F, and G.

Files or more generally user information can be restored back into the same place as the original user information without overwriting the information of file. For example, a file of the name ‘filename’ is to be restored, and it would be restored as ‘Restored File<timestamp>filename’. Files may be also restored back into alternative or new locations, directories, folders etc of the user's choosing.

With respect to directories and all subdirectories, these may be restored back and over the existing directories or restored to alternative or new directories of the user's choosing.

Furthermore, the files (or more generally any user information) do not necessarily need to be restored from necessarily where they came from (or for example, the device the 15 user information was originally backed up from). Instead they could be restored to another device to enable use of the particular file/data/information.

It has been found that in accordance with preferred embodiments delegation may be enabled by storing access control lists with the data it is possible therefore to limit a user to only restore data that they originally has access to. This means that only files that the specific user has access to can be restored by that user, thereby enabling file restoration to be performed by all in an organization without any security breach. Low end users may restore their files without the need for administrator intervention, etc. and because ACL's information is also restored, continuity of security policies may be assured. This may be especially prudent where a systems administrator does not need to have more access rights or privileges than the CEO of the organization, especially in the case of market/commercially sensitive information and thereby reducing ‘insider trading’ and ‘ransom’ scenarios and situations.

Users may easily restore their user information or data to a certain point in time, whether that is the baseline, baseline +n increments, current information, etc. without having to rely on other manual mechanisms (for e.g. thereby removing the risk that tapes have a failure) and merely selecting the target and date to restore up to.

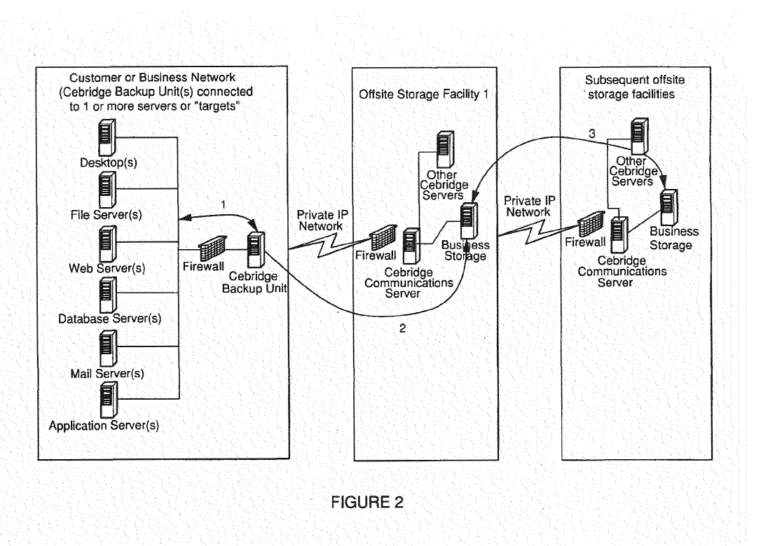

With reference to the schematic of FIG. 2, use is made of a device such as a Backup Unit (BU). The BU is an all-in-one hardware and software solution that is supplied as part of this embodiment that is connected to the user's network and provides a secure data backup facility at the organization's premises. The BU is an onsite device that may be adapted to perform the backup, prepare data for transport and perform onsite restores.

In a working system of a preferred embodiment, the method initially takes a complete snapshot of all the business data which is then optionally compressed and encrypted (if required) and then may be stored in physically separate locations of:

1. A supplied onsite Backup Unit (BU);

2. Operations centre offsite storage facility; and

3. Optionally, data is transported to subsequent offsite storage facilities.

With regard to security, the following may stated.

No two encryption keys are the same, they are usually password protected and these are not stored in either an operations centre or additional offsite storage areas meaning a user's data cannot be “accidentally” unlocked in either offsite location. The encryption keys being used do not necessarily need to reside on the BU, instead these keys could be stored and accessed on some other medium that interfaces with the BU for example on a USB stick resident at another facility for which the BD has access to. These encryption keys may be required for both encryption and decryption.

The onsite BU has firewall and username password protection protocols in place securing it from attack within or connected to the organization it is servicing. The onsite BD can also be configured to have physical security in the form of a propriety interface for screen and keyboard controls; and a key lock power switch. With regard to the initial handling of information, data capture is performed and in a preferred embodiment data capture components comprise the following.

The BD views the data it is backing up as a series of targets. A target may be an entire server or workstation or a component thereof. For example, the user network it is backing up may be made up of a file server, a mail server, a database server and two workstations etc. These servers and workstations may each have a different operating system. The user may decide to use a single BD for all the targets, although it is possible for a BU to be deployed for each target or series of targets. The user may recognize that their user information or data is the most important element to the ongoing operations of the organization. Hardware, operating system and application components may be easily and quickly reacquired in the open market. With that said all data components can be backed up by the BU. These servers and workstations may have many directories, their access may be governed by the particular organization's security policies and the individual applications—the BU has total access to these devices by ensuring that the backup unit has an appropriate username and password that can read and write data to that device, usually a system administrator password or equivalent and using the appropriate connection regime. By connection regime, each operating system has if you will a standard Application Programming Interface (API) which is used to access systems. Each type of operating system has this standard and it allows users to connect to these devices i.e. much in the same way as a user can connect to the file server, the present system uses the backup unit to select the appropriate operating system mechanism/standard in conjunction with the username/password to gain access and interrogate the device for data to be backed up or to restore data.

The BU is preferably configured to take a backup of the data in 24 hour intervals on the file and mail servers, 6 hour intervals on the database server and 7 day intervals on the workstations. These backups are instigated automatically from the resident BU either via a predefined schedule or alternatively immediately by a user instigated initiation. Failure to initiate the backup or perform a connection at the prescribed time from the BU sets off a series of alarms at both the on and offsite devices. Alarms may include but not be limited to splash screen alerts, email, SMS and other visual and audible alarms.

A previously described, the BU would initially take a complete snapshot of all defined data and then the changes in that data at pre-defined time or some other data backup regime that the user requires. The preferred solution uses the notion of a baseline i.e. all the data at that precise point of time of the initial backup of the target. Conceivably, the baseline could be something other than all the data at a particular point of time. There is the possibility here of backing up data and having n=0 increments, not compressing it, not encrypting it and only keeping it onsite which caters for situations where data does not require these elements to be applied or they are considered low risk/cost. Then n number of subsequent backups are performed, where n is configurable. Once the number of backups reaches n+1, the first backup would be merged into the baseline, the n+1 backup would become n and so on. It is noted that if during a backup it is discovered that a file (or some portion of user information, generally) has been deleted from the target it is backing up, it would NOT be deleted from the BU or offsite storage.

The preferred solution also uses an overlap approach to backing up data. In general other data backup solutions enable either a full backup (i.e. take a backup of all data at a moment in time); perform a differential (i.e. only take data that has changed for a prescribed piece of time once a baseline is established where that baseline is a full backup of data); or to take a incremental (i.e. only take a backup of data that has changed since the last backup). The present embodiment enables an overlap regime to be applied. For example let us say that the user has configured the backup to run every 24 hours and that the overlap is for 7 (seven) day, the algorithm would:

Check for when that last backup was successfully performed. There may be specific instances where the backup does not run every 24 hours, but let say it is run for every weekday;

The overlap is as noted for 7 days;

The overlap algorithm would perform a calculation of which is greater (i.e. that last backup or the noted 7 days) and backup all new data that meet that criteria.

Alternative related art backup regimes with the software loaded onto the target device interrupt and use the resources of the device it is backing up. Potentially, given the resources and the amount of data, a backup may interrupt the day to day operations of that device and may not necessarily complete within a minimum 24 hour window. With the preferred embodiment there is no software loaded onto the target device(s) and the only interruption is a minimal amount of network traffic to transfer the data from the source device (or target) to the BU, thereafter the BU and offsite components are capable of acting and functioning independently of the targets that they are backing up.

With an alternative related art data replication solution, once a file is deleted, it would be deleted on the system that houses the replication thereby totally removing the 25 data from future restoration possibilities. With the present embodiment that data is never deleted, it may be replaced depending upon the configuration model employed, but it is never deleted. Again by example, say a file named document.doc. was created. The present system backs that data up. Then a user deletes the file named document.doc, the present system does not delete as it is really looking for data that has been changed and added, not deleted. So whether it is 6 hours or 6 years later the document may be retrieved.

The baseline aspect of embodiments of the solution enables complete flexibility. For instance with the BU it may be configured to have a baseline plus 30 increments, the first offsite facility has a baseline plus 365 increments, the second offsite facility has a baseline plus infinity or any combination thereof. Once the baseline has been taken, there is further flexibility with the preferred solution, namely:

Users can define how much compression there is in the backup;

Users can define the strength of the data encryption key; and

Enable data backup overlap. For instance Users may require that while the backup is instigated every 24 hours, that the backup being performed looks at all data that has changed in the previous 48 hours. The preferred solution can also integrate what alternative backup regimes perform incorporating the preferred baseline approach with the following approaches:

Users may require that the second and subsequent backup only have incremental data, that is, data that has changed since the last backup was performed;

Users may require that only differential data be backed up after the initial data backup;

Users may require that only data created in the preceding 7 days or since the last successful backup be backed up after the initial data backup;

Users may require that a complete snapshot of all data be instigated each and every time.

The preferred embodiment allows for a proven requirement for business as for being able for example taking a “7 day” rolling approach to data changes means that an organization, especially in the case of extortion or attack, can enable decisive fact based analysis and remediation to be performed. By eliminating the “human hands” from the transport process also eliminates a potential security risk for organizations. In contrast, using the traditional or related art tape regime means that transport from the onsite to offsite facilities can be exploited by external parties intercepting the transport of this data. However, using the preferred solution virtually eliminates the security risk of interception and “human hands or handling.

The user may also choose not to have certain pieces of data (or targets) transported offsite and instead may be happy enough to have that data stored onsite. This is especially useful for SOHO (Small Office/Home Office) or the general public users that may not be able to or want offsite data storage either due to costs, data profile or offsite storage connectivity issues.

By using disks, utilizing easy to expand storage arrays and redundant array of independent disks (RAID) equates to faster backup and restoration processes. Also because the BU is an independent device it can be easily scaled and moves with the user. The same can be said of the offsite facilities.

With regard to the subsequent handling of information, that is, after data capture is performed, data restoration may be provided and in a preferred embodiment data restoration components comprise the following.

Data restoration can be performed directly from the onsite BU, from the offsite storage or in the case of a total disaster the data (and the associated encryption key 10 regime) can be moved to a “hot” or replacement BU and moved to an appropriate place for the business to continue operating. Additionally, the restoration of the data from an offsite facility to an onsite facility can be performed directly to the new source without having the load the data onto a “hot” or replacement BU. In contrast, using a related art tape system for backups and restoration is labor intensive and potentially non compliant in trying to restore a piece of data that has been deleted. With the preferred solution a user could retrieve a file (presumably lost 12 months ago) quickly and easily and with that may find that it was actually created 6 or 18 months ago.

Should a device fail, and an immediate replacement device is not available, the data to be restored does not necessarily need to be restored back to the device (or server/workstation) it originated from. For example a file server fails, a replacement server won't be physically available for 24 hours, but the user needs to access this file while the replacement server is being sourced, the data can be restored to a device of the Users choosing enabling the business to continue operating. In a tape, mirrored or storage area network (SAN) regime this would not be easily possible without the device having the necessary hardware/software components to support that regime. The BU does not require any software to be loaded onto the device it is either backing up or restoring too.

As noted above, an internal attack, a rampant Trojan or a Virus represents a serious risk to all organizations. Restoring an organizations data up to and including a certain point in time is vital to recover from these threats. With the preferred solution Users can easily restore data to a certain point in time, whether that is the baseline, baseline+n increments, a complete current view of data or other combinations of requirements without having to rely on other manual mechanisms (thereby removing the risk that tapes have a failure) and merely selecting the target and the date to restore that data up to. By way of example, this may be achieved by initially taking a baseline copy, the Trojan/virus attacks after the baseline and or subsequent backups are made, then restore back to the appropriate point in time before the attack. Viruses/Trojans will “change or delete” files and when subsequent backups are taken it is possible to notice significant changes bringing an “alert” also these things would also be noticed within the baseline+n regime where n at the onsite device is usually 30 and n at either at the offsite facilities may be greater than 30. Furthermore when restoring the clean data, it is possible to actually change a modified timestamp—which may be checked for as opposed to the creation date so that the system will back up the clean data again to place into the backup regime. Which then brings a question about removing the “infected files” before they are merged into the baseline which can be easily done as may be appreciated by the person skilled in the art.

Through the use of the preferred overlap algorithm organizations are further enabled to extend the functionality of the restoration for all the organizations data. Not only can organizations have data restored that was backed up on a particular date it can be instantly extended to be a range of dates. Further, with the offsite data storage (and associated baseline regime), the data can be “archived” at a moment in time and restored just as easily.

### Architecture & Storage Components

As described previously and illustrated in FIG. 2, the BU is an all-in-one hardware and software solution that is supplied as part of the complete preferred solution. The BU is connected to the user network and provides a secure data backup facility at the organizations premises. It in turn connects to the offsite facility via a telecommunication connection preferably on a private IP network using either a normal telephone line, an Internet connection or ideally a virtual private network in order to transport the changes of the business data, where it is backed up for the second time. This data transfer process can then be replicated from the second site to other offsite facilities or incorporate other components to backup the backup data. The BU can be a server of any size, dependant upon the size of organizations data requirements. It would at a minimum have mirrored disk drives and for the larger target(s) and baseline regime the BU may also have extended RAID and incorporate aspects of a storage area network (SAN) in order to facilitate larger storage requirements. The BU has its own base operating system with a web server, database server and file storage components (for example Linux server) either incorporated onto the one unit or delivered as separate units for each of the core components of web access, storage and database. The BU may have more than one network interface card (NIC)—or at least several network addresses using network address translation (NAT) applied—so as to separate the user network from the offsite network. The BU prepares and stores data for restoration as well as preparing data to place this into a queue for transport to the offsite facility. The data is stored on both the BU and offsite storage facilities in two distinct regimes; the raw data is compressed and may be encrypted, while its attributes (including and not limited to ACLs', file attributes, VERS components and data meta tags) are stored in a database to optimize manipulation and interrogation.

With respect to the offsite storage facilities, the following may be provided. Firstly, a server of any size, dependent upon the size of organizations offsite data requirements is provided. There can be either a one-to-one correlation between a BU and the offsite storage components or it can be a mass environment storing many Users' data. It would at a minimum have mirrored disk drives and for the larger user and baseline regime the offsite server regime may also have extended RAID and incorporate aspects of a storage area network (SAN) in order to facilitate larger storage requirements. It would have its own base operating system with a web server, database server and file storage components (for example Linux server) either incorporated onto the one unit or delivered as separate units. It would also have more than one network interface card (NIC)—or at least several network addresses using network address translation (NAT) applied—so as to separate the BU connection network from its own internal offsite network. The offsite server(s) receives and stores data for restoration. The offsite facility works with individual BU's in constantly polling and checking when data is ready for transport and to be received from a User's premises. The offsite server(s) enables quick and easy browser connection to the user BU it is servicing by performing the necessary address translation needed to establish connection to the required BU rather than having to remember the precise address to establish connection to the required BU.

The BU and offsite facilities can grow on demand. Only communication with recognized and established BU's can communicate with the offsite facilities. Data can be “trickled” from the BU to the offsite facility, so much so that over time, if necessary, it can “catch up” and be in complete synchronization between the on and offsite data storage as transport data waits in queues for transport. BU's can communicate to one offsite facility and then data is transported onto a second offsite facility or a BU can communicate directly with 1 or more offsite facilities. Unauthorized or accidental access or theft of offsite data is eliminated by removing data encryption key from the offsite storage facilities. The offsite facilities also enables a holistic network management approach in tracking, monitoring and managing the onsite BU's. Through this facility, operators can instigate data restoration as if they were at the User's premises and even use the same web based interface. Furthermore with this facility other network and data management service capability can be enabled offering the total network management solution for User's as it would be able to capture alarms, alerts, trends and thereby be proactive in the ongoing network, data and knowledge management initiatives of organizations. The on and offsite data storage regime can either be offered as a service for many User's or be used within the one organization that has many offices or a combination of the two. Data can be restored either directly by the onsite BU, onto a another BU for transport and activation to a new user site in the event of a major disaster or data restored directly from the offsite facility to the User's premises. And finally, with other solutions offsite data recovery can be limited by the amount of data to be restored or the establishment and size of its link to the Users' premises. The preferred approach removes all of these barriers for quick and efficient restoration by having a device onsite and directly connected will make restoration quicker and easier. In contrast, if a user has used the Internet to store a backup of all their data, its efficiency is dependent upon how big a connection they have. It is always faster to have the data onsite for restoration which we have enabled in preferred embodiments.

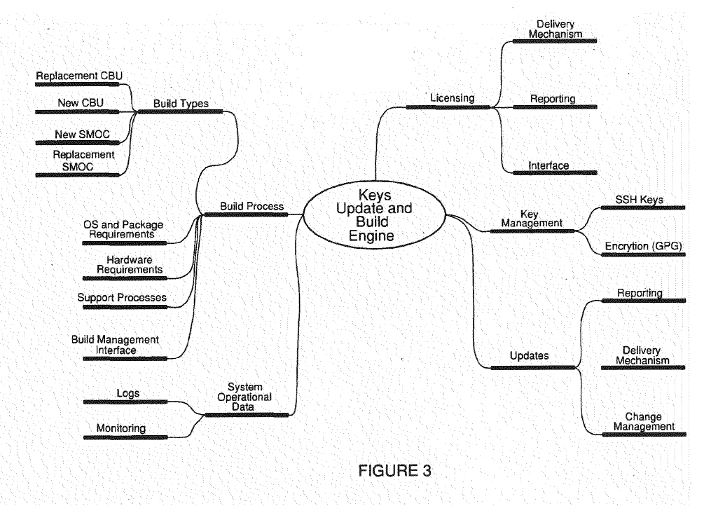

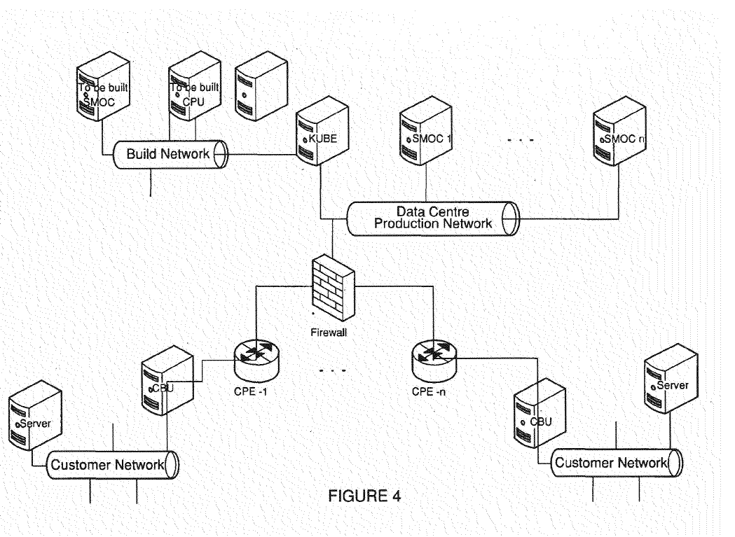

With reference to FIG. 3, there is provided an Update and Build engine (CUBE). The CUBE is the preferred key, build, update and licensing engine. BU's and Secure Mobile Operations Centers (SMOC's) connect to this CUBE device to be built and receive updates. The conceptual overview of the CUBE is illustrated in FIG. 3 as an overview with the logical and physical aspects illustrated in FIG. 4.

Other functional components that the CUBE performs are as follows. Ideally a BU or SMOC in the field would connect bi-weekly/monthly to the CUBE. The CUBE would store a copy of all transport (e.g. ssh) and data encryption (e.g. gpg) keys for Users. It would perform license count and authorizations. It would copy and clean logs from BU and SMOC devices so as to perform detailed analysis for future enhancements and performance tuning. It would store and manage all code and associated updates for

Hardware

Operating System

Kernel

Libraries

Programs

Website

Database or Data Interrogation and Manipulation Approach

With reference to the overview of FIG. 4 it is shown that the SMOC is the offsite device, storing a copy of the BU data. One or more BU's connect to a SMOC. The overall schematic of how the CUBE would interface within a closed environment is illustrated in FIG. 4. Furthermore, a CUBE may be part of a hierarchical structure, with master and slave CUBEs so as to distribute updates, perform licensing and collect data where one or more operations centers (or indeed operators) would be present in the operation of the preferred solution's method.

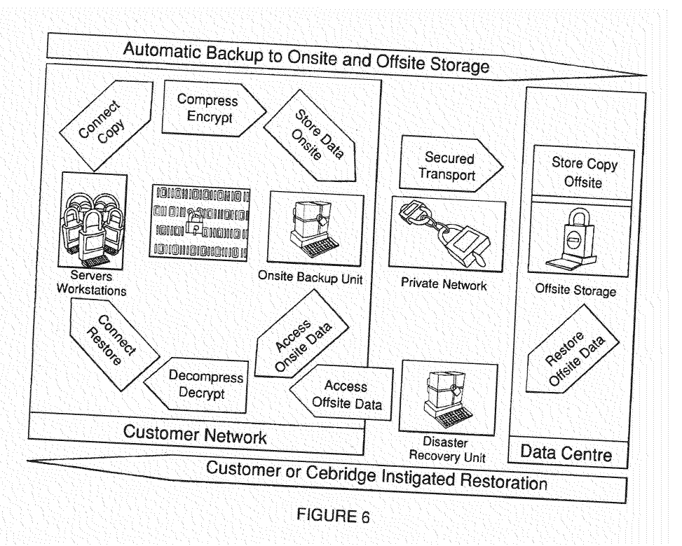

FIG. 6 is a further schematic diagram illustrating a backup system and approach in accordance with a preferred embodiment while not necessarily being the only approach for the delivery of this system, for example, recovery of data from an offsite situation could be performed directly from the offsite location straight back to a device of the customers choosing rather than having to first place it onto another backup unit to perform the onsite restoration.

### BU, SMOC & CUBE Hardware

The BU may be installed on varying network environments and the specific requirements for a user need to be taken into account when building and specifying the BU to be deployed.

The construction and deployment of a BU has the following applied:

Intel based motherboards (preferably with onboard video and NIC) although other types of generally available motherboards could also be used.

Intel based processors although other types of generally available processors could also be used.

Intel based network interface cards (NIC) should more than I NIC be required, although other types of generally available NICs could also be used.

Western Digital (WD) or Seagate (SG) Hard Disks (HDD), although other types of generally available hard disks could also be used.

Minimum 300 W power supply.

As a minimum two (2) mirrored drives are to be used for a BU—in this case the controller (e.g. 3 Ware) RAID cards are used in a normal PC tower configuration.

In the case of more than two (2) drives being used the mandatory use of controller (e.g. 3 Ware) RAID cards or SAN systems and associated software would be used in the BU build combined with a rack mountable configuration.

The construction and deployment of a SMOC has the following applied:

Intel based motherboards (preferably with onboard video and NIC) although other types of generally available motherboards could also be used.

Intel based processors although other types of generally available processors could also be used.

Intel based network interface cards (NIC) should more than 1 NIC be required, although other types of generally available NICs could also be used

Western Digital (WD) or Seagate (SG) Hard Disks (HDD), although other types of generally available hard disks could also be used.

Minimum 300 W power supply.

As a minimum two (2) mirrored drives are to be used for a SMOC—in this case the controller (e.g. 3 Ware) RAID cards are used in a normal PC tower configuration.

In the case of more than two (2) drives being used the mandatory use of controller (e.g. 3 Ware) RAID cards or SAN systems and associated software would be used in the SMOC build combined with a rack mountable configuration.

The construction and deployment of a CUBE has the following applied:

Intel based motherboards (preferably with onboard video and NIC) although other types of generally available motherboards could also be used.

Intel based processors although other types of generally available processors could also be used.

Intel based network interface cards (NIC) should more than 1 NIC be required, although other types of generally available NICs could also be used

Western Digital (WD) or Seagate (SG) Hard Disks (HDD), although other types of generally available hard disks could also be used.

Minimum 300 W power supply.

As a minimum two (2) mirrored drives are to be used for a CUBE in this case the controller (e.g. 3 ware) RAID cards are used in a normal PC tower configuration.

In the case of more than two (2) drives being used the mandatory use of controller (e.g. 3 Ware) RAID cards or SAN systems and associated software would be used in the CUBE build combined with a rack mountable configuration.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that 15 the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

It should be noted that where the terms “server”, “secure server” or similar terms are used herein, an electronic communication device is described that may be used in a communication system, unless the context otherwise requires, and should not be construed to limit the present invention to any particular communication device type.

It should also be noted that where a flowchart or its equivalent is used herein to demonstrate various aspects of the invention, it should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often, logic elements may be added, modified, omitted, performed in a different order, or implemented using different logic constructs (e.g., logic gates, looping primitives, conditional logic, and other logic constructs) without changing the overall results achieved or otherwise departing from the true scope of the invention.

Various embodiments of the invention maybe embodied in many different forms, comprising computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means comprising any combination thereof. In an exemplary embodiment of the present invention, predominantly all of the 20 communication between users and one or more servers may be implemented as a set of computer program instructions that is converted into a computer executable form, stored as such in a computer readable medium, and executed by a microprocessor under the control of an operating system.

Computer program logic implementing all or part of the functionality where described herein may be embodied in various forms, comprising a source code form, a computer executable form, and various intermediate forms (e.g., forms generated by an assembler, compiler, linker, or locator). Source code may comprise a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

A computer program implementing all or part of the functionality where described herein may be fixed in any form (e.g., source code form, computer executable form, or an intermediate form) either permanently or transitorily in a tangible storage medium, such as a semiconductor memory device (e.g., a RAM, ROM, PROM, EEPROM, or Flash Programmable RAM), a magnetic memory device (e.g., a diskette 01: fixed disk), an optical memory device (e.g., a CD-ROM or DVD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (comprising programmable logic for use with a programmable logic device) implementing all or part of the functionality where described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

“Comprises/comprising” when used in this specification is taken to specify the presence of stated features, integers, steps or components but does not preclude the presence or addition of one or more other features, integers, steps, components or groups thereof.” Thus, unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

1. A method of handling user information, said method comprising the steps of:
(a) generating a baseline wherein said baseline includes a copy of an initial collection of user information;
(b) storing at least a predefined number of subsequent copies of predetermined user information; and
(c) regenerating said baseline by merging said copy of predetermined user information stored immediately subsequent to a previously generated baseline with said previously generated baseline.

2. A method of handling user information according to claim 1 further comprising a step of regenerating said baseline when said number of subsequent copies stored equates to said predefined number+1.

3. A method of handling user information according to claim 2 further comprising a step of repeating said step of regenerating said baseline for each copy of predetermined user information stored subsequent to when the number of subsequent copies stored equates to said predefined number+1.

4. A method of handling user information according to claim 1 wherein said predetermined user information is selected from the group consisting essentially of incremental user information, differential user information, incremental user information plus a user required amount of differential user information, a complete collection of user information, user file data, access control lists, VERS information, and associated constructed meta data tags user information that has changed prior to storing a previous copy of predetermined user information.

5. (canceled)

6. A method of handling user information according to claim 1 wherein in the event a portion of user information is deleted in a subsequent copy, further comprising a step of a previous copy of said portion of user information that is deleted is to be retained in at least one of said previous copies or said baseline.

7. A method of handling user information according to claim 1 further comprising a step of compressing copies of the user information prior to said steps of:
(a) generating a baseline;
(b) storing at least a predefined number of subsequent copies of predetermined user information, and;
(c) regenerating said baseline.

8. A method of handing user information according to claim 1 further comprising a step of performing a first and subsequent encryption of copies of the user information prior to said steps of:
(a) generating a baseline;
(b) storing at least a predefined number of subsequent copies of predetermined user information, and;
(c) regenerating said baseline.

9. (canceled)

10. A method of handling user information according to claim 1 further comprising a step of performing an encrypted transport of the user information to at least one offsite facility.

11. (canceled)

12. (canceled)

13. (canceled)

14. (canceled)

15. A method of handing user information according to claim 1 further comprising a step of restoring user information comprising:
providing the user access to anyone or a combination of:
(a) a current regenerated baseline;
(b) at least one previously generated baseline;
(c) an “as of date” current state of data between the current generated baseline and the latest performed backup; and
(d) at least one of the subsequent copies of stored predetermined user information.

16. (canceled)

17. A method of handling user information according to claim 1 further comprising a step of requiring user access via a user generated username, a password, and a decryption password if required.

18. A method of handing user information according to claim 1 further comprising a step of writing the restored user information to a location selected from the group consisting essentially of a location corresponding to its original place in the initial collection of user information, a location corresponding to its original place in the initial collection of user information with a different name to prevent overwriting the original user information, and an alternate location.

19. (canceled)

20. A method of handling user information to preserve electronic data generated at a source location, copied, and sent to at least one first onsite device that stores and manipulates the data, said method comprising the steps of:
(a) backing up the copied data to the first onsite storage device;
(b) preparing the data for offsite transport and offsite storage within the first onsite storage device to establish an initial collection of the electronic data;
(c) backing up a number of subsequent data increments where the number of increments, n being an integer such that n greater than or equal to 0 an, n is configurable;
(d) merging the first of the subsequent data increments with the collection when the number of increments reaches n+1 and;
(e) thereafter enlarging the collection by stepwise mergers.

21. A method of handing user information according to claim 20 wherein the data is prepared for offsite transport in a compressed and encrypted form and is further encrypted during transport and segmented onsite and reassembled at the offsite facility.

22. An apparatus for handling user information, comprising:
(a) a means for generating a baseline where said baseline comprises a copy of an initial collection of user information;
(b) a means for storing at least a predefined number of subsequent copies of predetermined user information; and
(c) a means for regenerating said baseline by merging said copy of predetermined user information stored immediately subsequent to a previously generated baseline with said previously generated baseline.

23. An apparatus for handling user information according to claim 22 wherein said regenerating means is adapted to regenerate said baseline when the number of subsequent copies stored equates to the predefined number+1, wherein said predefined number is greater than or equal to 0.

24. An apparatus for handling user information according to claim 23 wherein said regenerating means is further adapted to regenerate said baseline for each copy of predetermined user information stored subsequent to when the number of subsequent copies stored equates to the predefined number+1, wherein said predefined number is greater than or equal to 0.

25. (canceled)

26. (canceled)

27. An apparatus for handling user information according to claim 22 wherein in the event a portion of user information is deleted in a subsequent copy, said apparatus is adapted to retain a previous copy of said portion of user information that is deleted to be retained in at least one of said previous copies or said baseline.

28. An apparatus for handling user information according to claim 22 further comprises data compression means for compressing copies of the user information prior to:
(a) generating a baseline;
(b) storing at least a predefined number of subsequent copies of predetermined user information, and;
(c) regenerating the baseline.

29. An apparatus for handling user information according to claim 22 further comprising a data encryption means of the user information prior to:
(a) generating a baseline;
(b) storing at least a predefined number of subsequent copies of predetermined user information, and;
(c) regenerating the baseline.

30. (canceled)

31. An apparatus for handing user information according to claim 22 further comprising a means for transporting in an encrypted manner means for transporting said copies of the user information to at least one offsite facility.

32. (canceled)

33. (canceled)

34. (canceled)

35. (canceled)

36. An apparatus for handling user information according to claim 22 further comprising a means for restoring user information, comprising:
providing a user access to anyone or a combination of:
(a) a current regenerated baseline;
(b) at least one previously generated baseline;
(c) an “as of date” current state of data between the current generated baseline and the latest performed backup; and
(d) at least one of the subsequent copies of stored predetermined user information.

37. (canceled)

38. An apparatus for handling user information according to claim 22 further comprising a means for requiring user access via a user defined username, password, and a decryption password if required.

39. An apparatus for handling user information according to claim 22 further comprising a means for writing the restored user information to a location selected from the group consisting essentially of a location corresponding to its original place in the initial collection of user information, a location corresponding to its original place in the initial collection of user information with a different name to prevent overwriting the original user information, and an alternate location.

40. (canceled)

41. (canceled)

42. An apparatus for handling user information to preserve electronic data generated at a source location, copied and sent to at least one first onsite device that stores and manipulates the data, said apparatus comprising:
(a) a backup unit for backing up the data to the first onsite device, said backup unit being located onsite and adapted for preparing the data for onsite storage and offsite transport and the offsite storage to also have an initial collection, said backup unit further adapted for backing UP and storing a number of subsequent data increments where the number of increments, n is configurable;
(b) a data compression means for compressing the data; and
(c) an encryption means for encrypting the data;
(d) a merging means for merging the first of the subsequent data increments with said collection when the number of increments reaches n+1 and;
(e) a means for thereafter enlarging the collection by stepwise mergers.

43. An apparatus for handling user information according to claim 42 further comprising a means for preparing the data for offsite transport in its compressed and encrypted form and the apparatus further comprises additional encryption of the traffic and segmentation means for segmenting the data onsite and reassembly means for reassembling the data at an offsite facility.

44. An article of manufacture, comprising a machine accessible medium having instructions encoded thereon for enabling a processor to perform the operations of:
(a) generating a baseline wherein said baseline includes a copy of an initial collection of user information;
(b) storing at least a predefined number of subsequent copies of predetermined user information; and
(c) regenerating said baseline by merging said copy of predetermined user information stored immediately subsequent to a previously generated baseline with said previously generated baseline with said previously generated baseline.

45. (canceled)

46. (canceled)

47. (canceled)

48. (canceled)

49. (canceled)

50. (canceled)

51. (canceled)
